(19) United States
(12) Patent Application Publication
(10) Pub. No.: US 2007/0156937 A1
(43) Pub. Date: Jul. 5, 2007

(54) Data transfer in multiprocessor system

(76) Inventors: Nak-Hee Seong, Gwacheon-si (KR); Young-Duk Kim, Seoul (KR); Jae-Hong Park, Seongnam-si (KR); Young-Jun Kwon, Seongnam-si (KR); Jong-Min Lee, Seoul (KR)

Correspondence Address: LAW OFFICE OF MONICA H CHOI, P O BOX 3424, DUBLIN, OH, 430160204, US

(21) Appl. No.: 11/480,707

(22) Filed: Jul. 3, 2006

(30) Foreign Application Priority Data
Jan. 4, 2006 (KR) 2006-01041

(51) Int. Cl. G06F 13/00

(52) U.S. Cl. 710/110

(57) ABSTRACT

A multiprocessor system includes a plurality of masters, at least one first type of slave operating with a first clock frequency, and at least one second type of slave operating with a second clock frequency higher than the first clock frequency. An arbitrator coordinates access between the masters and the slaves via a single read/write bus path between the arbitrator and the first type of slave, and via a plurality of read bus paths and/or a plurality of write bus paths between the arbitrator and the second type of slave.

### CROSS-REFERENCE TO RELATED APPLICATION(S)

The present application claims priority under 35 U.S.C. §119 to Korean Patent Application No. 2006-01041, filed on Jan. 4, 2006, which is incorporated herein by reference in its entirety.

### TECHNICAL FIELD

The present invention relates generally to a multiprocessor system, and more particularly, to increasing effective bus bandwidth for a slave operating with higher clock frequency in the multiprocessor system.

### BACKGROUND OF THE INVENTION

FIG. 1 shows a block diagram of a general multiprocessor system 100 having a master block 102 and a slave block 104. The master block 102 has a plurality of masters including a first master 112, a second master 114, and so on up to an m-th master 116. Each of such masters 112, 114, through 116 is a data processor such as a CPU (central processing unit) or a DSP (digital signal processor) for example.

The slave block 104 has a plurality of slaves including a first slave 122, a second slave 124, and so on up to an n-th slave 126. Each of such slaves 122, 124, through 126 is accessed by at least one of the masters 112, 114, through 116. For example, each of such slaves 122, 124, through 126 is a memory device.

A bus arbitrator 130 arbitrates access to the slaves 122, 124, through 126 amongst the masters 112, 114, through 116 via a first bus 132 and a second bus 134 according to a priority policy. Generally, one of the masters 112, 114, through 116 is granted access to the buses 132 and 134 at a time for accessing one of the slaves 122, 124, through 126.

For example, assume that the first and second masters 112 and 114 each send a respective request to the bus arbitrator 130 for writing data into the second slave 124. The bus arbitrator responds by first granting access to the first master 112. In that case, the first master 112 sends control, address, and data signals to the bus arbitrator via the first bus 132. Thereafter, the bus arbitrator 130 sends such control, address, and data signals to the slave block 104 via the second bus 134. The second slave 124 which corresponds to the decoded address signal responds by writing data into its memory core.

Subsequently, the bus arbitrator 130 grants access to the second master 114 which in response sends control, address, and data signals to the bus arbitrator via the first bus 132. Thereafter, the bus arbitrator 130 sends such control, address, and data signals to the slave block 104 via the second bus 134. The second slave 124 which corresponds to the decoded address signal responds by writing data into its memory core.

FIG. 2 shows an example implementation for the bus arbitrator 130 with an AC (address and control) multiplexer 142, a WR (write) multiplexer 144, a RD (read) multiplexer 146, and a multiplexer controller 148. The first bus 132 between the master block 102 and the bus arbitrator 130 is comprised of an AC (address and control) master bus 152 for communication of AC (address and control) signals, a WR (write) master bus 154 for communication of write data, and a RD (read) master bus 156 for communication of read data. In addition, the second bus 134 between the bus arbitrator 130 and the slave block 104 is comprised of an AC (address and control) slave bus 162 for communication of AC (address and control) signals, a WR (write) slave bus 164 for communication of write data, and a RD (read) slave bus 166 for communication of read data.

The masters 112, 114, through 116 send address and control signals, ACM1, ACM2, through ACMm, respectively, to the AC multiplexer 142 via the AC master bus 152. The masters 112, 114, through 116 send write data, WRM1, WRM2, through WRMm, respectively, to the WR multiplexer 144 via the WR master bus 154. The masters 112, 114, through 116 receive read data, RDM1, RDM2, through RDMm, respectively, from the RD multiplexer 146, via the RD master bus 156.

The slaves 122, 124, through 126 receive address and control signals, ACS1, ACS2, through ACSn, respectively, from the AC multiplexer 142 via the AC slave bus 162. The slaves 122, 124, through 126 receive write data, WRS1, WRS2, through WRSn, respectively, from the WR multiplexer 144 via the WR slave bus 164. The slaves 122, 124, through 126 send read data, RDS1, RDS2, through RDSn, respectively, to the RD multiplexer 146, via the RD slave bus 166.

The multiplexer controller 148 generates a first control signal AC_SEL that controls the AC multiplexer 142 to select one of the address and control signals ACM1, ACM2, through ACMm from one of the masters 112, 114, through 116 having access as the address and control signals ACS1, ACS2, through ACSn respectively coupled to the slaves 122, 124, through 126. The selected address signal indicates one of the slaves 122, 124, through 126 being accessed, and such a selected slave responds with a data read operation or a data write operation.

The multiplexer controller 148 also generates a second control signal WR_SEL that controls the WR multiplexer 144 to select one of the write data WRM1, WRM2, through WRMm from one of the masters 112, 114, through 116 having access as the write data WRS1, WRS2, through WRSn respectively coupled to the slaves 122, 124, through 126. The multiplexer controller 148 further generates a third control signal RD_SEL that controls the RD multiplexer 146 to select one of the read data RDS1, RDS2, through RDSn from one of the slaves 122, 124, through 126 being accessed as the read data RDM1, RDM2, through RDMm respectively coupled to the masters 112, 114, through 116.

Read operations in the multiprocessor system 100 are now described in reference to a timing diagram of FIG. 3. Referring to FIGS. 2 and 3 at time point T0, the second slave 124 receives the address and control signal ACM1 as generated by the first master 112 for a first request to read data from the second slave 124. The multiplexer controller 148 generates the AC_SEL signal that controls the AC multiplexer 142 to select the address and control signal ACM1 from the first master 112 output as each of the address and control signals ACS1, ACS2, through ACSn respectively coupled to the slaves 122, 124, through 126.

Just the second slave 124 corresponding to the address signal specified in the ACM1 signal responds by preparing a first read data corresponding to the ACM1 signal during a time period T2 to T4. After an interfacing time period T2 to T3, the second slave 124 begins to output the first read data as RDS2 onto the RD slave bus 166.

Current memory devices operate with higher speed performance such that the second slave 124 operates with higher clock frequency than the buses 164 and 166. The interfacing time period T2 to T3 is for the read data crossing over from the higher clock frequency of the second slave 124 to the lower clock frequency of the RD slave bus 166.

The second slave 124 has the first read data prepared during a relatively short time period T2 to T4 because the second slave 124 operates with higher clock frequency. However, the first read data is output to the RD slave bus 166 for a relatively longer time period T3 to T6 because the RD slave bus 166 operates with lower clock frequency.

In addition at time point T1 in FIG. 3, the second slave 124 receives the address and control signal ACM2 as generated by the second master 114 for a second request to read data from the second slave 124. The multiplexer controller 148 generates the AC_SEL signal that controls the AC multiplexer 142 to switch to the address and control signal ACM2 from the second master 114 output as each of the address and control signals ACS1, ACS2, through ACSn respectively coupled to the slaves 122, 124, through 126.

The second slave 124 corresponding to the address signal specified in the ACM2 signal responds by preparing a second read data corresponding to the ACM2 signal during a time period T4 to T5, after the first read data has already been prepared. Such second read data is ready to be output to the RD slave bus 166 at time point T5. However, the RD slave bus 166 is being used for outputting the first read data for the first master 112 until time point T6. At that time point T6, the second read data is output as RDS2 to the RD slave bus 166 for a time period T6 to T7.

Note that also for the second read data, the second slave 124 has the second read data prepared during a relatively short time period T4 to T5 since the second slave 124 operates with higher clock frequency. However, the second read data is output to the RD slave bus 166 for the relatively longer time period T6 to T7 because the RD slave bus 166 operates with lower clock frequency.

Such long time periods T3 to T6 and T6 to T7 for outputting the first and second read data onto the RD slave bus 166 disadvantageously slow down the operation of the multiprocessor system 100.

FIG. 4 is a timing diagram showing example write operations in the multiprocessor system 100. Referring to FIGS. 2 and 4 at time point T0, the second slave 124 receives the address and control signal ACM1 as generated by the first master 112 for a first request to write data into the second slave 124. The multiplexer controller 148 generates the AC_SEL signal that controls the AC multiplexer 142 to select the address and control signal ACM1 from the first master 112 output as each of the address and control signals ACS1, ACS2, through ACSn respectively coupled to the slaves 122, 124, through 126.

Just the second slave 124 corresponding to the address signal specified in the ACM1 signal responds by inputting a first write data from the WR slave bus 164 during a time period T2 to T4. In addition, after an interfacing time period T2 to T3, the second slave 124 begins to write the first write data as WRS2 into its memory core.

The second slave 124 writes the first write data into its memory core during a relatively short time period T3 to T5 because the second slave 124 operates at higher clock frequency. However, the first write data is input from the WR bus 164 for a relatively longer time period T2 to T4 because the WR slave bus 164 operates with lower clock frequency.

In addition at time point T1 in FIG. 4, the second slave 124 receives the address and control signal ACM2 as generated by the second master 114 for a second request to write data into the second slave 124. The multiplexer controller 148 generates the AC_SEL signal that controls the AC multiplexer 142 to select the address and control signal ACM2 from the second master 114 output as each of the address and control signals ACS1, ACS2, through ACSn respectively coupled to the slaves 122, 124, through 126.

Just the second slave 124 corresponding to the address signal specified in the ACM2 signal responds by inputting a second write data from the WR slave bus 164 during a time period T4 to T7. In addition, the second slave 124 begins to write the second write data as WRS2 into its memory core after an interfacing time period T4 to T6.

The second slave 124 writes the second write data into its memory core during a relatively short time period T6 to T8 because the second slave 124 operates at higher clock frequency. However, the second write data is input from the WR slave bus 164 for a relatively longer time period T4 to T7 because the WR slave bus 164 operates with lower clock frequency.

Such long time periods T2 to T4 and T4 to T7 for inputting the first and second write data from the WR bus 164 disadvantageously slow down the operation of the multiprocessor system 100.

One solution for such disadvantages is to speed up the operation of the buses 164 and 166. Another solution is to decrease the interfacing times T2 to T3 in FIG. 3 and T2 to T4 and T4 to T6 in FIG. 4. However, such solutions are costly.

Thus, a low cost mechanism is desired for preventing such slow operation of the multiprocessor system 100 when the buses 162 and 164 operate with lower clock frequency than any of the slaves 122, 124, through 126.

### SUMMARY OF THE INVENTION

Accordingly, in a general aspect of the present invention, a plurality of read and/or write bus paths are formed for a slave operating with higher clock frequency.

A multiprocessor system according to one example embodiment of the present invention includes a plurality of masters, at least one first type of slave operating with a first clock frequency, and at least one second type of slave operating with a second clock frequency higher than the first clock frequency. The multiprocessor system also includes an arbitrator for coordinating access between the masters and the slaves and includes a single read/write bus path between the arbitrator and the first type of slave. The multiprocessor system further includes a plurality of read bus paths and/or a plurality of write bus paths between the arbitrator and the second type of slave.

The second type of slave outputs read data onto the multiple read bus paths with time overlap and/or inputs write data from the multiple write bus path with time overlap, especially when the bus paths operate with a lower clock frequency. The arbitrator includes multiplexers and a multiplexer controller for coordinating transmission of data with such time overlap between the plurality of masters and the plurality of slaves.

In this manner, because data is transmitted via the multiple bus paths with time overlap, the slower clock frequency of the bus paths does not slow down the operation of the multiprocessor system having slaves operating at higher clock frequency.

These and other features and advantages of the present invention will be better understood by considering the following detailed description of the invention which is presented with the attached drawings.

### BRIEF DESCRIPTION OF THE DRAWINGS

FIG. 1 shows a block diagram of a general multiprocessor system, as known in the prior art;

FIG. 2 shows a block diagram of an example multiprocessor system with a single read bus path and a single write bus path between each of the slaves and a bus arbitrator, according to the prior art;

FIG. 3 shows a timing diagram for read operations in the multiprocessor system of FIG. 2, according to the prior art;

FIG. 4 shows a timing diagram for write operations in the multiprocessor system of FIG. 2, according to the prior art;

FIG. 5 shows a block diagram of a multiprocessor system with a plurality of read and write bus paths for each slave operating at higher clock frequency, according to an embodiment of the present invention;

FIG. 6 shows a timing diagram for read operations in the multiprocessor system of FIG. 5, according to an embodiment of the present invention;

FIG. 7 shows a timing diagram for write operations in the multiprocessor system of FIG. 5, according to an embodiment of the present invention; and

FIG. 8 shows a block diagram of a slave interface for a slave operating at higher clock frequency in the multiprocessor system of FIG. 5, according to an embodiment of the present invention.

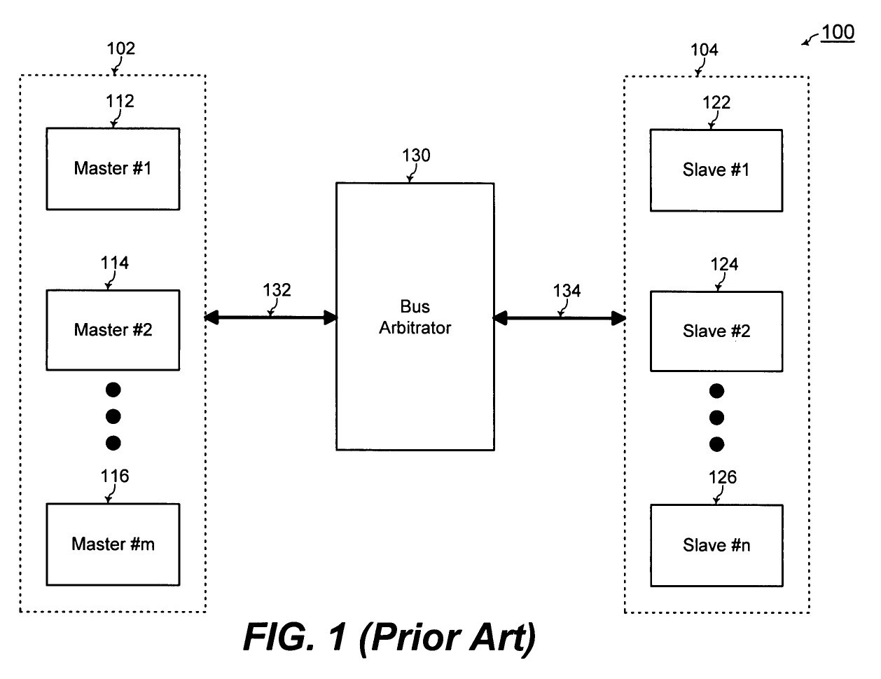

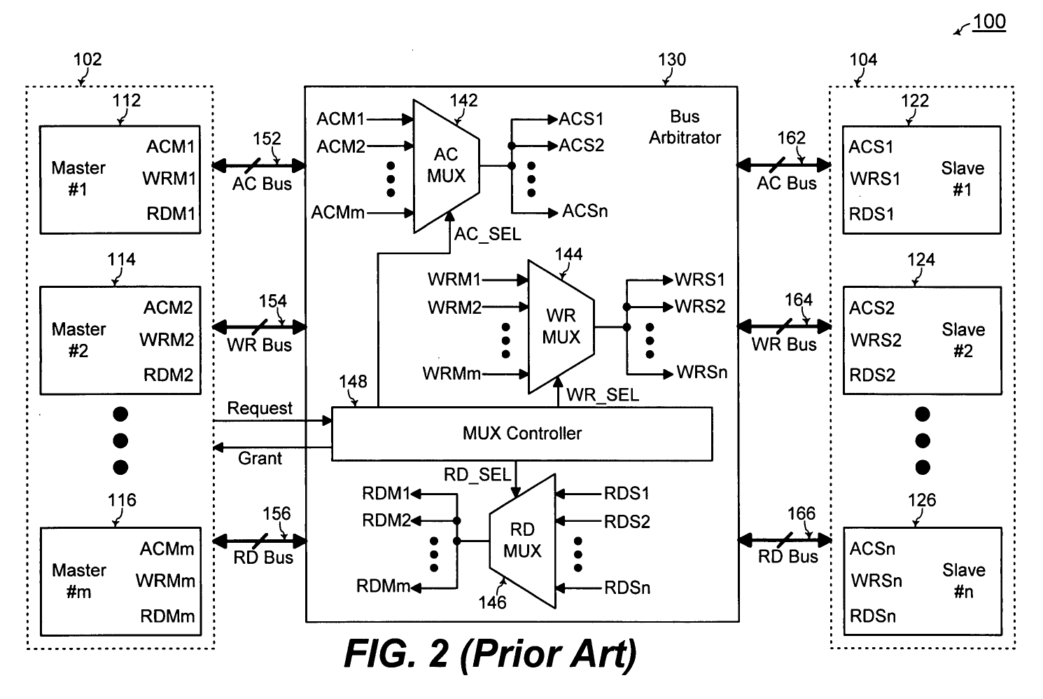

The figures referred to herein are drawn for clarity of illustration and are not necessarily drawn to scale. Elements having the same reference number in FIGS. 1, 2, 3, 4, 5, 6, 7, and 8 refer to elements having similar structure and/or function.

### DETAILED DESCRIPTION

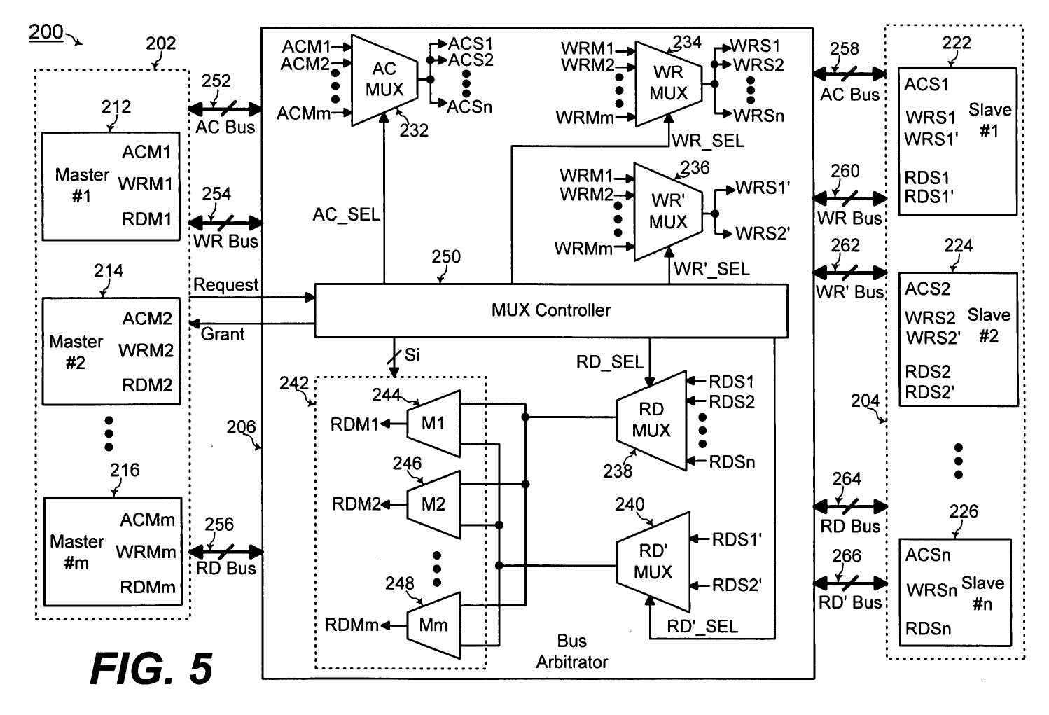

FIG. 5 shows a block diagram of a multiprocessor system 200 according to an embodiment of the present invention. The multiprocessor system 200 includes a master block 202, a slave block 204, and a bus arbitrator 206. The master block 202 has a plurality of masters including a first master 212, a second master 214, and so on up to an m-th master 216. Each of such masters 212, 214, through 216 is a data processor such as a CPU (central processing unit) or a DSP (digital signal processor) for example.

The slave block 204 has a plurality of slaves including a first slave 222, a second slave 224, and so on up to an n-th slave 226. Each of such slaves 222, 224, through 226 is accessed by at least one of the masters 212, 214, through 216. For example, each of such slaves 222, 224, through 226 is a memory device.

The n-th slave 226 is of a first type operating with a first clock frequency, and the first and second slaves 222 and 224 are of a second type operating with a second clock frequency that is higher than the first clock frequency. In an example embodiment of the present invention, the rest of the slaves such as the n-th slave 226, aside from the faster slaves 222 and 224, in the slave block 204 are of the first type that operates with the lower clock frequency.

The bus arbitrator 206 arbitrates access to the slaves 222, 224, through 226 amongst the masters 212, 214, through 216. To that end, the bus arbitrator 206 includes a plurality of multiplexers including an AC (address and control) multiplexer 232, a first WR (write) multiplexer 234, a second WR′ (write) multiplexer 236, a first RD (read) multiplexer 238, and a second RD′ (read) multiplexer 240.

The bus arbitrator 206 also includes a signal selector 242 comprised of m-multiplexers including a first selector multiplexer 244, a second selector multiplexer 246, and so on up to an m-th selector multiplexer 248. A multiplexer controller 250 generates control signals for controlling the multiplexers 232, 234, 236, 238, 240, 244, 246, through 248 according to a priority policy.

The masters 212, 214, through 216 send address and control signals, ACM1, ACM2, through ACMm, respectively, to the AC multiplexer 232 via an AC (address and control) master bus 252. The masters 212, 214, through 216 send write data, WRM1, WRM2, through WRMm, respectively, to the first WR multiplexer 234 via a WR (write) master bus 254. The masters 212, 214, through 216 receive read data, RDM1, RDM2, through RDMm, respectively, from the signal selector 242 via a RD (read) master bus 256.

The slaves 222, 224, through 226 receive address and control signals, ACS1, ACS2, through ACSn, respectively, from the AC multiplexer 234 via an AC (address and control) slave bus 258. The slaves 222, 224, through 226 receive first write data, WRS1, WRS2, through WRSn, respectively, from the first WR multiplexer 234 via a first WR (write) slave bus 260. The faster slaves 222 and 224 operating with higher clock frequency receive second write data, WRS1′ and WRS2′, respectively, from the second WR′ multiplexer 236 via a second WR′ (write) slave bus 262.

The slaves 222, 224, through 226 send first read data, RDS1, RDS2, through RDSn, respectively, to the first RD multiplexer 238 via a first RD (read) slave bus 264. The faster slaves 222 and 224 operating with higher clock frequency send second read data, RDS1′ and RDS2′, respectively, to the second RD′ multiplexer 240 via a second RD′ (read) slave bus 266.

In this manner, the faster slaves 222 and 224 operating with the higher clock frequency each have respective two write bus paths via the WR and WR′ slave buses 260 and 262 and via the WR and WR′ multiplexers 234 and 236. Similarly, the faster slaves 222 and 224 each have respective two read bus paths via the RD and RD′ slave buses 264 and 266 and via the RD and RD′ multiplexers 238 and 240.

On the other hand, any slower slave 226 operating with the lower clock frequency has a single write bus path via the first WR slave bus 260 and the first WR multiplexer 234. Similarly, the slower slave 226 has a single read bus path via the first RD slave bus 264 and the first RD multiplexer 238.

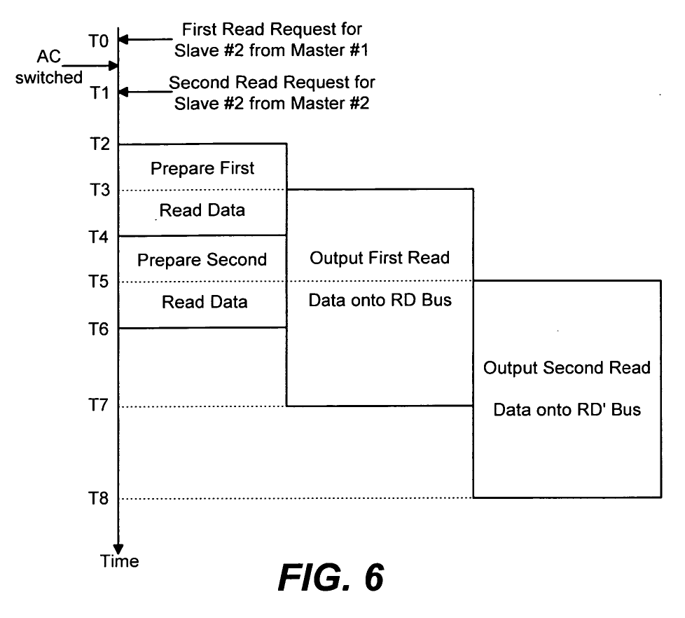

Read operations in the multiprocessor system 200 are now described in reference to a timing diagram of FIG. 6. Referring to FIGS. 5 and 6 at time point T0, the second slave 224 receives the address and control signal ACM1 as generated by the first master 212 for a first request to read data from the second slave 224. The multiplexer controller 250 generates an AC_SEL signal that controls the AC multiplexer 232 to select the address and control signal ACM1 from the first master 212 output as each of the address and control signals ACS1, ACS2, through ACSn respectively coupled to the slaves 222, 224, through 226.

Just the second slave 224 corresponding to the address signal specified in the ACM1 signal responds by preparing a first read data RDS2 corresponding to the ACM1 signal during a time period T2 to T4. After an interfacing time period T2 to T3, the second slave 224 begins to output the first read data as RDS2 onto the first RD slave bus 264.

The multiplexer controller 250 generates a RD_SEL signal that controls the first RD multiplexer 238 to select the first read data RDS2 from the second slave 224 as its output. The multiplexer controller 250 also generates an S₁ signal that controls the first selector multiplexer 244 to select the output of the first RD multiplexer 238 as the read data RDM1 coupled to the first master 212. In this manner, the first read data RDS2 from the second slave 224 is directed to the first master 212.

The second slave 224 operates at a slave clock frequency that is higher than a bus clock frequency for the first RD slave bus 264. The interfacing time period T2 to T3 is for the first read data crossing over from the higher clock frequency of the second slave 224 to the lower clock frequency of the first RD slave bus 264.

The second slave 224 has the first read data RDS2 prepared during a relatively short time period T2 to T4 because the second slave 224 operates with higher clock frequency. However, the first read data RDS2 is output to the first RD slave bus 264 for a relatively longer time period T3 to T7 because the first RD slave bus 264 operates with lower clock frequency.

In addition at time point T1 in FIG. 6, the second slave 224 receives the address and control signal ACM2 as generated by the second master 214 for a second request to read data from the second slave 224. The multiplexer controller 250 generates the AC_SEL signal that controls the AC multiplexer 232 to switch to the address and control signal ACM2 from the second master 214 output as each of the address and control signals ACS1, ACS2, through ACSn respectively coupled to the slaves 222, 224, through 226 (as indicated by “AC switching” in FIG. 6).

The second slave 224 corresponding to the address signal specified in the ACM2 signal responds by preparing a second read data RDS2′ corresponding to the ACM2 signal during a time period T4 to T6, after the first read data RDS2 has already been prepared. After an interfacing time period T4 to T5, the second slave 224 begins to output the second read data RDS2′ onto the second RD′ slave bus 266.

The multiplexer controller 250 generates a RD′_SEL signal that controls the second RD′ multiplexer 240 to select the second read data RDS2′ from the second slave 224 as its output. The multiplexer controller 250 also generates an S₂ signal that controls the second selector multiplexer 246 to select the output of the second RD′ multiplexer 240 as the read data RDM2 coupled to the second master 214. In this manner, the second read data RDS2′ from the second slave 224 is directed to the second master 214.

The second slave 224 has the second read data RDS2′ prepared during a relatively short time period T4 to T6 because the second slave 224 operates with higher slave clock frequency. However, the second read data RDS2′ is output to the second RD′ slave bus 266 for a relatively longer time period T5 to T8 because the second RD′ slave bus 266 operates with lower bus clock frequency.

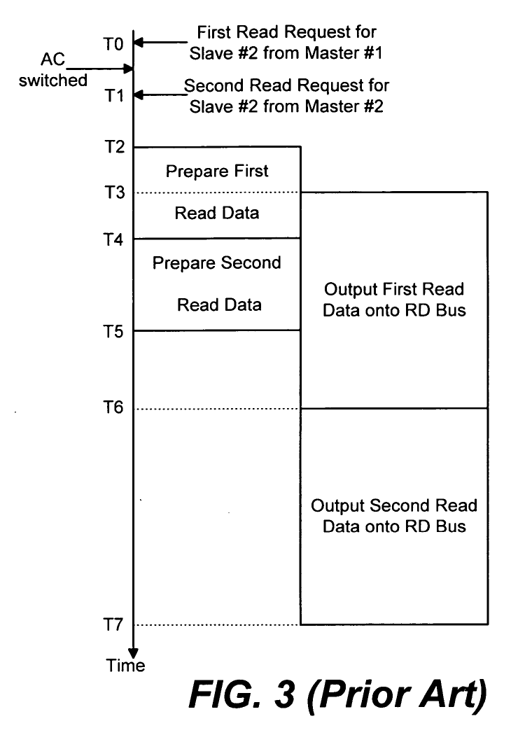

Nevertheless, the second slave 224 has two read bus paths such that the first and second read data RDS2 and RDS2′ are output onto the first and second RD and RD′ read slave buses 264 and 266 with time overlap T5 to T7 in FIG. 6. Such time overlap decreases the overall time T3 to T8 in FIG. 6 for outputting the first and second read data RDS2 and RDS2′ from the second slave 224 compared to the overall time (T3 to T7 in FIG. 3) of the prior art.

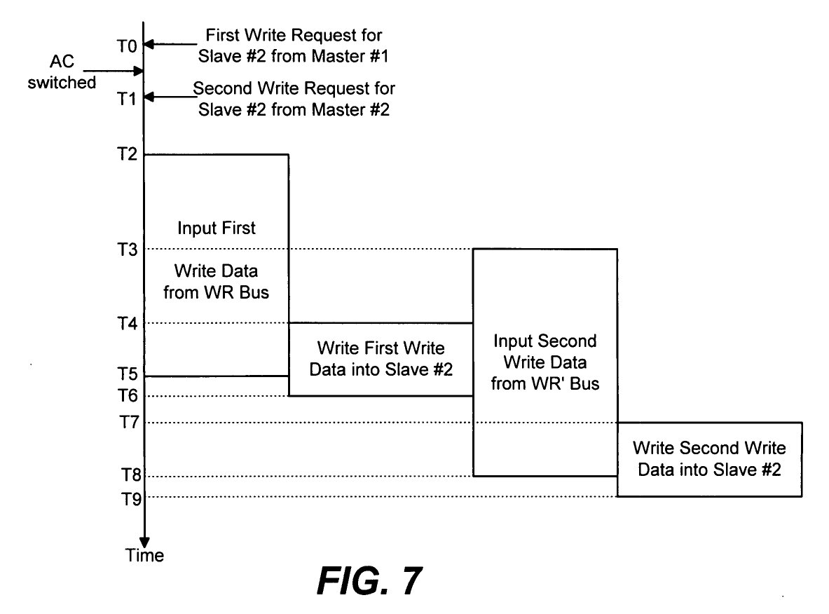

FIG. 7 is a timing diagram showing example write operations in the multiprocessor system 200. Referring to FIGS. 5 and 7 at time point T0, the second slave 224 receives the address and control signal ACM1 as generated by the first master 212 for a first request to write data into the second slave 224. The multiplexer controller 250 generates the AC_SEL signal that controls the AC multiplexer 232 to select the address and control signal ACM1 from the first master 212 output as each of the address and control signals ACS1, ACS2, through ACSn respectively coupled to the slaves 222, 224, through 226.

In addition, the multiplexer controller 250 generates a WR_SEL signal that controls the first WR multiplexer 234 to select the first write data WRM1 from the first master 212 output as each of the first write data, WRS1, WRS2, through WRSn, respectively coupled to the slaves 222, 224, through 226 via the first WR slave bus 260. Just the second slave 224 corresponding to the address signal specified in the ACM1 signal responds by inputting the first write data WRS2 from the first WR slave bus 260 during a time period T2 to T5. In addition, after an interfacing time period T2 to T4, the second slave 224 begins to write the first write data WRS2 into its memory core.

The second slave 224 writes the first write data WRS2 into its memory core during a relatively short time period T4 to T6 because the second slave 224 operates at higher clock frequency. However, the first write data WRS2 is input from the first WR slave bus 260 for a relatively longer time period T2 to T5 because the first WR slave bus 260 operates with lower clock frequency.

In addition at time point T1 in FIG. 7, the second slave 224 receives the address and control signal ACM2 as generated by the second master 214 for a second request to write data into the second slave 224. The multiplexer controller 250 generates the AC_SEL signal that controls the AC multiplexer 232 to select the address and control signal ACM2 from the second master 214 output as each of the address and control signals ACS1, ACS2, through ACSn respectively coupled to the slaves 222, 224, through 226 (as indicated by “AC switching” in FIG. 7).

In addition, the multiplexer controller 250 generates a WR′_SEL signal that controls the second WR′ multiplexer 236 to select the second write data WRM2 from the second master 214 output as each of the second write data WRS1′ and WRS2′ respectively coupled to the faster slaves 222 and 224 via the second WR′ slave bus 262. Just the second slave 224 corresponding to the address signal specified in the ACM2 signal responds by inputting a second write data WRS2′ from the second WR′ slave bus 262 during a time period T3 to T8. In addition, the second slave 224 begins to write the second write data WRS2′ into its memory core after an interfacing time period T3 to T7.

The second slave 224 writes the second write data WRS2′ into its memory core during a relatively short time period T7 to T9 because the second slave 224 operates at higher clock frequency. However, the second write data WRS2′ is input from the second WR′ slave bus 262 for a relatively longer time period T3 to T8 because the second WR′ slave bus 262 operates with lower clock frequency.

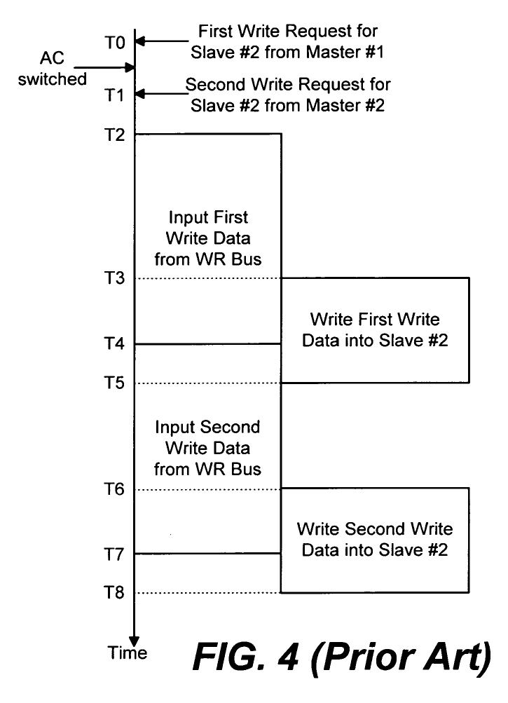

Nevertheless, the second slave 224 has two write bus paths such that the first and second write data WRS2 and WRS2′ are input from the first and second WR and WR′ write slave buses 260 and 262 with time overlap T3 to T5 in FIG. 7. Such time overlap decreases the overall time T2 to T8 in FIG. 7 for inputting the first and second write data WRS2 and WRS2′ into the second slave 224 compared to the overall time (T2 to T7 in FIG. 4) of the prior art.

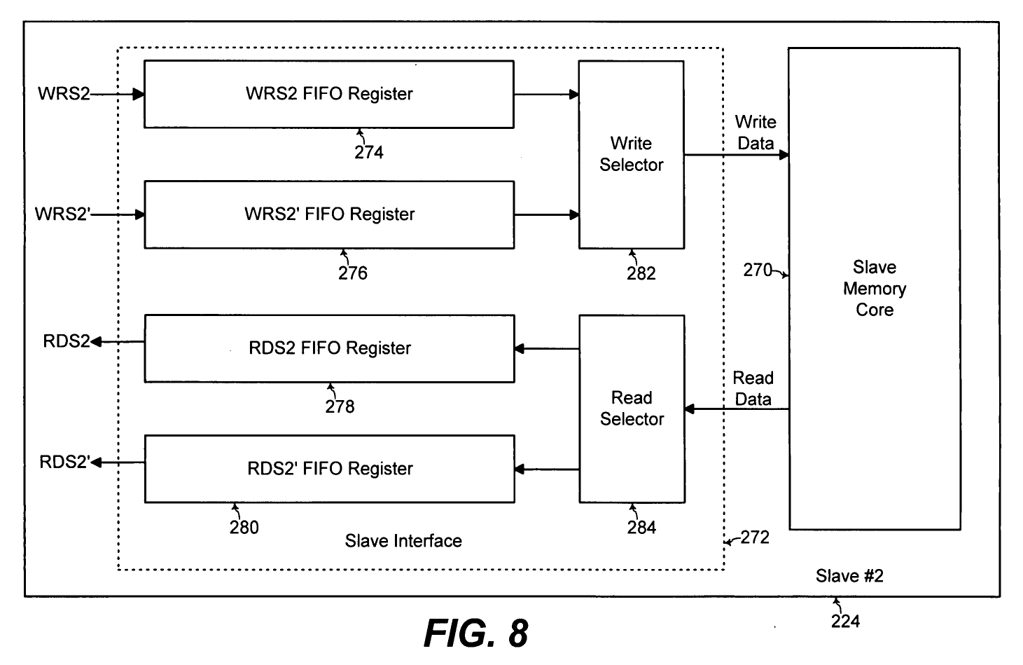

FIG. 8 shows a block diagram of an example one of the slaves 222 and 224 operating at higher clock frequency such as the second slave 224. The second slave 224 includes a memory core 270 and a slave interface 272. The slave interface includes a first write data register 274, a second write data register 276, a first read data register 278, and a second read data register 280. A write selector 282 is coupled between the write data registers 274 and 276 and the memory core 270. A read selector 284 is coupled between the read data registers 278 and 280 and the memory core 270.

Referring to FIGS. 6 and 8, the read selector 284 routes the first read data RDS2 from the memory core 270 into the first read data register 278 during time period T2 to T4, and routes the second read data RDS2′ from the memory core 270 into the second read data register 280 during time period T4 to T6. Such read data transfer from the memory core 270 is synchronized to the higher clock frequency of the memory core 270, and such read data transfer occurs sequentially into the read data registers 278 and 280.

Also referring to FIGS. 6 and 8, the first read data register 278 outputs the first read data RDS2 onto the first RD slave bus 264 during time period T3 to T7. The second read data register 280 outputs the second read data RDS2′ onto the second RD′ slave bus 266 during time period T5 to T8. The first and second read data registers 278 and 280 output the first and second read data RDS2 and RDS2′ onto the first and second RD and RD′ slave buses 264 and 266, respectively, with time overlap T5 to T7. Such read data transfer onto the RD and RD′ slave buses 264 and 266 from the read data registers 278 and 280 is synchronized to the lower clock frequency of the slave buses 264 and 266.

Referring to FIGS. 7 and 8, the write selector 282 routes the first write data WRS2 from the first write data register 274 into the memory core 270 during time period T4 to T6, and routes the second write data WRS2′ from the second write register 276 into the memory core 270 during time period T7 to T9. Such write data transfer into the memory core 270 is synchronized to the higher clock frequency of the memory core 270, and such write data transfer occurs sequentially from the write data registers 274 and 276.

Also referring to FIGS. 7 and 8, the first write data register 274 inputs the first write data WRS2 from the first WR slave bus 260 during time period T2 to T5. The second write data register 276 inputs the second write data WRS2′ from the second WR′ slave bus 262 during time period T3 to T8. The first and second write data registers 274 and 276 input the first and second write data WRS2 and WRS2′ from the first and second WR and WR′ slave buses 260 and 262, respectively, with time overlap T3 to T5. Such write data transfer from the WR and WR′ slave buses 260 and 262 into the write data registers 272 and 276 is synchronized to the lower clock frequency of the slave buses 260 and 262.

In this manner, latency in data transfer onto or from a bus is minimized even when the bus clock frequency is less than the slave clock frequency by using X-number of write bus paths and X-number of read bus paths for the faster slave. In one embodiment of the present invention, the clock frequency of a slower bus 260, 262, 264, or 266 multiplied by X is greater than the clock frequency of a faster slave 222 or 224. Such multiple write bus paths and multiple read bus paths allow for time overlap in reading data from or writing data onto the slower buses for minimizing latency in data processing for the multiprocessor system 200.

The foregoing is by way of example only and is not intended to be limiting. For example, any number of elements as illustrated and described herein is by way of example. The present invention is limited only as defined in the following claims and equivalents thereof.

1. A multiprocessor system, comprising:
a plurality of masters;
at least one first type of slave operating with a first clock frequency;
at least one second type of slave operating with a second clock frequency higher than the first clock frequency;
an arbitrator for coordinating access between the masters and the slaves;
a single read/write bus path between the arbitrator and the first type of slave; and
a plurality of read bus paths or a plurality of write bus paths between the arbitrator and the second type of slave.

2. The multiprocessor system of claim 1, further comprising:
a plurality of read bus paths and a plurality of write bus paths between the arbitrator and the second type of slave.

3. The multiprocessor system of claim 1, including a single read bus path between the arbitrator and the first type of slave, and including a pair of read bus paths between the arbitrator and the second type of slave, and wherein the arbitrator includes:
a first read multiplexer for selecting among the single read bus path and one of the pair of read bus paths, for transmitting read data from one of the slaves to one of the masters.

4. The multiprocessor system of claim 3, including a plurality of the second type of slaves, each second type of slave having a respective pair of read bus paths, and wherein the arbitrator includes:
a second read multiplexer for selecting among a respective one read bus path for each of the respective pairs of read bus paths, for transmitting read data from one of the second type of slaves to one of the masters.

5. The multiprocessor system of claim 1, including a single write bus path between the arbitrator and the first type of slave, and including a pair of write bus paths between the arbitrator and the second type of slave, and wherein the arbitrator includes:
a first write multiplexer for selecting among the single write bus path and one of the pair of write bus paths, for transmitting write data to one of the slaves from one of the masters.

6. The multiprocessor system of claim 5, including a plurality of the second type of slaves, each second type of slave having a respective pair of write bus paths, and wherein the arbitrator includes:
a second write multiplexer for selecting among a respective one write bus path for each of the respective pairs of write bus paths, for transmitting write data to one of the second type of slaves from one of the masters.

7. The multiprocessor system of claim 1, including a pair of read bus paths between the arbitrator and the second type of slave, and wherein the second type of slave includes:
a pair of read data registers for storing read data that is transferred from a slave core sequentially for the pair of read data registers and synchronized to a slave clock, wherein the read data stored in the read data registers are transmitted with time overlap via the read bus paths and synchronized to a bus clock.

8. The multiprocessor system of claim 7, wherein the slave clock is faster than the bus clock.

9. The multiprocessor system of claim 1, including a pair of write bus paths between the arbitrator and the second type of slave, and wherein the second type of slave includes:
a pair of write data registers for storing write data that is received from the write bus paths with time overlap and synchronized to a bus clock, and wherein the write data from the write data registers are stored into a slave core sequentially for the pair of write data registers and synchronized to a slave clock.

10. The multiprocessor system of claim 9, wherein the slave cock is faster than the bus clock.

11. The multiprocessor system of claim 1, including a pair of read bus paths between the arbitrator and the second type of slave, wherein both of the read bus paths transmit respective read data from the second type of slave to the arbitrator with time overlap.

12. The multiprocessor system of claim 1, including a pair of write bus paths between the arbitrator and the second type of slave, wherein both of the write bus paths transmit respective write data to the second type of slave from the arbitrator with time overlap.

13. A multiprocessor system, comprising:
a plurality of masters;
a plurality of slaves;
an arbitrator for coordinating access between the masters and the slaves; and
a respective plurality of write bus paths between each of at least one of the slaves and the arbitrator.

14. The multiprocessor system of claim 13, including a single write bus path between the arbitrator and one of the slaves, and including a pair of write bus paths between the arbitrator and another one of the slaves, and wherein the arbitrator includes:
a first write multiplexer for selecting among the single write bus path and one of the pair of write bus paths, for transmitting write data to one of the slaves from one of the masters.

15. The multiprocessor system of claim 14, including a respective pair of write bus paths for at least two of the slaves, and wherein the arbitrator includes:
a second write multiplexer for selecting among a respective one write bus path for each of the respective pairs of write bus paths, for transmitting write data to one of the slaves from one of the masters.

16. The multiprocessor system of claim 13, including a pair of write bus paths between the arbitrator and one of the slaves that has:
a pair of write data registers for storing write data that is received from the write bus paths with time overlap and synchronized to a bus clock, and wherein the write data from the write data registers are stored into a slave core sequentially for the pair of write data registers and synchronized to a slave clock.

17. The multiprocessor system of claim 16, wherein the slave clock is faster than the bus clock.

18. The multiprocessor system of claim 13, including a pair of write bus paths between the arbitrator and one of the slaves, wherein both of the write bus paths transmit respective write data to the one of the slaves from the arbitrator with time overlap.

19. A method of transferring data in a multiprocessor system, comprising:
operating at least one first type of slave with a first clock frequency;
operating at least one second type of slave with a second clock frequency higher than the first clock frequency;
arbitrating access between a plurality of masters and the slaves;
transmitting data to/from the first type of slave via a single read/write bus path; and
transmitting data to/from the second type of slave via a plurality of read bus paths or a plurality of write bus paths.

20. The method of claim 19, further comprising:
transmitting data to/from the second type of slave via a plurality of read bus paths and a plurality of write bus paths.

21. The method of claim 19, further comprising:
transmitting read data from the first type of slave via a single read bus path;
transmitting read data from the second type of slave via a pair of read bus paths; and
selecting among the single read bus path and one of the pair of read bus paths, for transmitting read data from one of the slaves to one of the masters.

22. The method of claim 19, further including:
transmitting respective read data for each of a plurality of the second type of slaves via a respective pair of read bus paths; and
selecting among a respective one read bus path for each of the respective pairs of read bus paths, for transmitting read data from one of the second type of slaves to one of the masters.

23. The method of claim 19, further including:
transmitting write data to the first type of slave via a single write bus path;
transmitting write data to the second type of slave via a pair of write bus paths; and
selecting among the single write bus path and one of the pair of write bus paths, for transmitting write data to one of the slaves from one of the masters.

24. The method of claim 19, further including:
transmitting respective write data to each of a plurality of the second type of slaves via a respective pair of write bus paths; and
selecting among a respective one write bus path for each of the respective pairs of write bus paths, for transmitting write data to one of the second type of slaves from one of the masters.

25. The method of claim 19, further including:
transmitting read data from the second type of slave via a pair of read bus paths;
transferring the read data into a pair of read data registers from a slave core sequentially for the pair of read data registers and synchronized to a slave clock; and
transferring the read data stored in the read data registers to the pair of read bus paths with time overlap and synchronized to a bus clock.

26. The method of claim 25, wherein the slave clock is faster than the bus clock.

27. The method of claim 19, further including:
transmitting write data to the second type of slave via a pair of write bus paths;
transferring the write data into a pair of write data registers from the pair of write bus paths with time overlap and synchronized to a bus clock; and
transferring the write data from the write data registers into a slave core sequentially for the pair of write data registers and synchronized to a slave clock.

28. The method of claim 27, wherein the slave clock is faster than the bus clock.

29. The method of claim 19, further including:
transmitting respective read data from the second type of slave via each of a pair of read bus paths with time overlap.

30. The method of claim 19, further including:
transmitting respective write data to the second type of slave via each of a pair of write bus paths with time overlap.
